(19) United States
(12) Patent Application Publication
(10) Pub. No.: US 2011/0108516 A1
(43) Pub. Date: May 12, 2011

(54) ERGONOMIC SPORTS BOTTLE HAVING DISPOSABLE LINER

(76) Inventor: James McFarland, Chino, CA (US)

(21) Appl. No.: 12/755,882

(22) Filed: Apr. 7, 2010

Related U.S. Application Data
(60) Provisional application No. 61/167,469, filed on Apr. 7, 2009.

(51) Int. Cl. B65D 90/02; B23P 17/04

(52) U.S. Cl. 215/382; 29/428

(57) ABSTRACT

A novel bottle being ergonomically designed for active consumers is disclosed herein. In a preferred embodiment, the bottle has a design ideally shaped to mate to a user's hand that is ideally suited to walkers or even runners, for example. The embodiment further comprises an outer container having a vent hole, and an inner liner further coupled to a one-way valve; and together, this combination of structure reduces sloshing as is common in a partially filled bottle. Additionally, the inner liner is disposable and biodegradeable, and therefore the bottle outer container does not have to be washed or through away, that may otherwise pollute our environment, and increase consumption of raw materials. Ideally, the sports bottle herein comprises low-density polyethylene for comfort and easy squeezing of the outer container. Also, a novel method for lining a sports bottle (or bottle for other purpose) is disclosed herein.

### PRIORITY CLAIM

This utility patent application contains subject matter claiming benefit of the priority date of U.S. Provisional Patent Application Ser. No. 61/167,469, filed on Apr. 7, 2009, accordingly, the entire contents of this provisional patent application is hereby expressly incorporated by reference.

### BACKGROUND OF THE INVENTION

1. Field of the Invention

The present invention pertains generally to ergonomic accessories for active consumers and methods of environmental preservation, in addition to preserving manufactured and raw materials. More particularly, the invention relates to liquid dispensing receptacles. In a preferred embodiment, the invention is useful as a reusable bottle device having a biodegradable, disposable liner with additional features adding ease and comfort to the consumer.

2. Description of the Prior Art

Many outdoor use squeezed bottles and other potable liquid dispensing containers have been introduced heretofore. Some such designs have additionally employed in inner liner coupled to an outer container, such as those applicable to baby bottles, for example U.S. Pat. No. 6,631,819, entitled “Insulated And Luminescent Nursing Bottle,” to Diak/Ghanem. Another baby bottle liner was proposed by Koehnke, entitled “Sealable Slip-In Baby Bottle Liner,” U.S. Pat. No. 6,050,432. A further baby bottle liner was proposed by Sprehe, entitled “Reclosable Plastic Bag,” U.S. Pat. No. 7,467,893. While each appear suitable for their intended purposes, none of these proposals are particularly suited to a sports bottle intended for active users.

Sports bottles intended for active users engaged in cycling, running, hiking and walking, for example have also been proposed heretofore. Generally, these designs tout a squeezable bottle, easily actuated, insulated, and resistant to splashing. One such invention was granted patent protection in 1992 to Monahan et al., entitled “Insulated Water Bottle for A Bicycle,” U.S. Pat. No. 5,094,363. This particular design boasts its superior insulative properties, however many other issues pertaining to outdoor/active use of a sports bottle remain.

A problem that remains unaddressed in the art is that even sports bottles that have an inner liner for insulation would have to be cleaned after use to prevent buildup of harmful bacteria. This remains true for the user that solely consumes water with the sports bottle. In fact, unless the water bottle is sanitized, then it is likely that harmful bacteria in the water bottle will remain also resulting in a foul aftertaste. Additionally, the prior art has addressed the issue of splashing and spilling during active use, but however, the issue of sloshing caused by a partially full sports bottle has not been address anywhere in the extensive prior art.

Examples of other known water container include U.S. Pat. No. 4,938,389 to Rossi et al., entitled “Filter Bottle;” U.S. Pat. No. 5,076,922 to DeAre entitled “Water Filtration Apparatus;” U.S. Pat. No. 5,120,437 to Williams entitled “Portable Water Filtration Apparatus;” U.S. Pat. No. 5,505,342 to Okamura et al. entitled “Composite Container for Low Viscosity Liquids And A Method of Manufacturing The Same;” U.S. Pat. No. 7,114,624 to Van Parys entitled “Fluid Distribution Device Having A Bottle And A Decorative Case;” and U.S. Pat. No. 7,270,244 to Liu entitled “Polycarbonate Double Walled Liquid Holding Vessel.”

Additionally, motivation for the present invention was provided by the effects of non-biodegradable plastic waste in the environment. Such pollutants have reportedly formed a very large garbage patch in the Pacific Ocean, sometimes referred to the Great Pacific Garbage Patch. Hence, the present invention seeks to promote a reusable sports bottle having a disposable liner, the liner further being biodegradable. Further the present invention seeks to fill a demand providing by an increasing number of outdoor enthusiasts. According to one estimate, there are 40 million runners in the United States alone.

In light of the above, it is an object of the present invention to provide an ergonomic sports bottle design particularly for active users. More specifically, it is an object of the present invention to provide a bottle design that can ideally mate with a user's hand in a front aspect; yet in a side aspect, its shape is aerodynamic for storing on a bicycle, for example. It is an additional object of the present invention to provide an ergonomic bottle design that prevents a partially empty container from sloshing and making an annoying noise. It is still a further object of the present invention to provide a disposable liner to the design thereby eliminating harmful bacteria to reusable bottles that are not washed and sanitized properly after each use. It is yet further an object of the present invention to provide a squeezable and flexible design coupled to a one-way valve (FIG. 2B prior art) providing a precise flow without having to significantly tilt the bottle. It is yet still a further object of the present invention to provide a method of inserting a bottle into a liner that maximizes expansion of the liner within the bottle.

### BRIEF SUMMARY OF THE INVENTION

The present invention specifically addresses and alleviates the above mentioned deficiencies associated with the prior art. More particularly, the present invention in a first aspect is a bottle comprising: a mouth portion at a top end of the bottle; a body portion, the body portion having a diameter at a top end of the body portion; and a collar portion therebetween, wherein the mouth portion has a diameter, and wherein the collar portion has a diameter greater than both the diameter at the top end of the body portion and the mouth portion diameter, and wherein the mouth portion, the collar portion and body portion together form an integral unit.

The present invention is further characterized in that the body portion further comprises: first and second lateral sides in a side aspect; and third and fourth lateral sides in a front aspect, wherein the first and second lateral sides in a side aspect form a straight profile of the sides, and wherein the third and fourth lateral sides are curved in the front aspect, the third and fourth lateral sides further comprising a textured surface providing traction to a hand of a user. The bottle also has an outer surface, an inner surface; and a disposable inner liner for receiving and holding a liquid, wherein the inner liner is removably attached to the mouth and the outer surface, and wherein the disposable liner is surrounded by the inner surface of the bottle.

The invention is additionally characterized in that the bottle further comprises: squeezable low density polyethylene (LDPE) material; a cap having a one-way valve, configured to fit over the mouth and over the inner liner removably attached to the mouth and the outer surface; and a vent hole at an upper area of the body portion, such that, when a user places a finger over the vent hole and squeezes, the liquid is forced out of the one way valve thereby lowering pressure within the inner liner thereby causing the liner to collapse, and wherein a collapsing liner functions to dampen down sloshing of a remaining liquid in the inner liner, and when a user releases the finger over the vent hole pressure equalizes in a space between the inner and outer liner.

Further, the inner liner additionally comprises: a front side; and a back side connected to the front side with and edge comprising a fold on lateral side, the back side further connected to the front side via a seam on a bottom side, the inner liner further comprising biodegradable material. Also, the body portion of the bottle further comprises a bottom end including an ellipse having a major axis and a minor axis, wherein the minor axis equals the diameter at the top end of the body portion.

The bottle is additionally characterized wherein the bottom end major axis is greater than a width of the collar portion, and wherein the width of the collar portion is greater than a width of the mouth portion. The bottom end further comprises a ridge protruding around the bottom end, the ridge bisected by the major axis; and a groove in the ridge in an area bisected by the major axis.

In a second aspect, the present invention may be characterized as a bottle comprising: a mouth portion at a top end of the bottle, the mouth portion having an inner and an outer surface; a body portion including a vent hole, and a disposable inner liner for receiving and holding a liquid, wherein the disposable inner liner is removably attached about the inner and outer surface of the mouth.

The invention in this aspect is further characterized in that bottle body portion further comprising: a top end having a diameter; and a bottom end including an ellipse having a major axis and a minor axis, wherein the minor axis equals the diameter at the top end of the body portion. The bottle is additionally characterized in that the body portion further comprises, first and second lateral sides in a side aspect, and third and fourth lateral sides in a front aspect, wherein the first and second lateral sides in a side aspect form a straight profile of the sides, and wherein the third and fourth lateral sides are curved in the front aspect, the third and fourth lateral sides further comprising a textured surface providing traction to a hand of a user.

The bottle further comprises a collar portion between the mouth portion and the body portion, wherein the mouth portion has a diameter, and wherein the collar portion has a diameter greater than both the diameter at the top end of the body portion and the mouth portion diameter, and wherein the mouth portion, the collar portion and body portion together form an integral unit.

The invention in this aspect is also characterized in that it comprises squeezable low density polyethylene (LDPE) material; and a cap having a one-way valve, configured to fit over the mouth and over the inner liner removably attached about the inner and outer surface of the mouth, wherein, when a user places a finger over the vent hole and squeezes, the liquid is forced out of the one way valve thereby lowering pressure within the inner liner thereby causing the liner to collapse, and wherein a collapsing liner functions to dampen down sloshing of a remaining liquid in the inner liner, and when a user releases the finger over the vent hole pressure equalizes between the inner and outer liner. Still further, the invention is characterized in that the inner liner has a front side; and a back side connected to the front side with and edge comprising a fold on lateral side, the back side further connected to the front side via a seam on a bottom side, the inner liner further comprising biodegradable material.

In still another aspect, the invention is characterized as a method of lining a sports bottle comprising: providing a biodegradeable liner; inserting the liner through a mouth of the sports bottle; rolling the liner over the mouth of the sports bottle; forcing air into the liner to expand the liner within the sports bottle; and venting air in an area between the liner and the sports bottle out a vent hole in a body portion of the sports bottle.

Additionally, the method herein is further characterized as comprising the step of smoothing out the liner over the mouth of the sports bottle. Also, the inserting the liner through the mouth of the sports bottle comprises folding the liner lengthwise to assist the inserting. The method is further characterized as comprising lining up a logo on the liner with a logo on the sports bottle preceding the forcing air and following the inserting.

The method is further characterized as comprising providing threads to an outside of the mouth of the sports bottle; securing a cap to the mouth of the sports bottle; and ensuring the liner does not rotate causing a misalignment of the logo on the liner with the logo on the sports bottle.

The invention can be better visualized by turning now to the following drawings wherein like elements are referenced by like numerals.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective illustration of a preferred embodiment of the present invention in a preferred position;

FIG. 2B is a profile view of a prior art fluid dispensing valve that is coupled to the present invention in a preferred embodiment;

FIG. 2C illustrates a front plan view of the first preferred invention embodiment;

FIG. 2D is a bottom view thereof;

FIG. 2E is a top plan view thereof;

FIG. 3A is a perspective view of a liner illustrated a relation to a bottle design of the present invention;

FIG. 4A is a partial perspective view demonstrative of an initial method step;

FIG. 4B is partial perspective view demonstrative of an intermediate method step; and

FIG. 4C is partial perspective view demonstrative of a later method step.

### DETAILED DESCRIPTION OF PREFERRED EMBODIMENTS

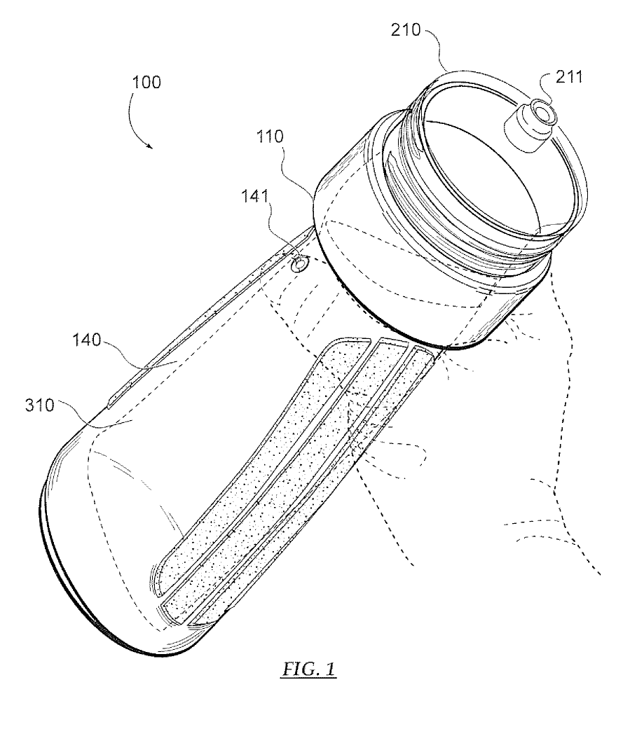

With reference to FIG. 1, a preferred embodiment 100 of the present invention is illustrated in perspective. As shown in a preferred position, a user will apply pressure to the bottle 110 while placing a thumb or a finger over vent hole 141, thus increasing pressure within the capped 210 bottle 100 above a threshold amount. When this threshold is reached, valve 211 will unseat and provide a precise stream of potable liquid to a user with a high enough flow rate so that the bottle 100 does not have to be substantially tilted. It is contemplated herein that this design is ideal for bicyclist, runners, walkers, skiers, hikers and other sport or outdoor enthusiasts.

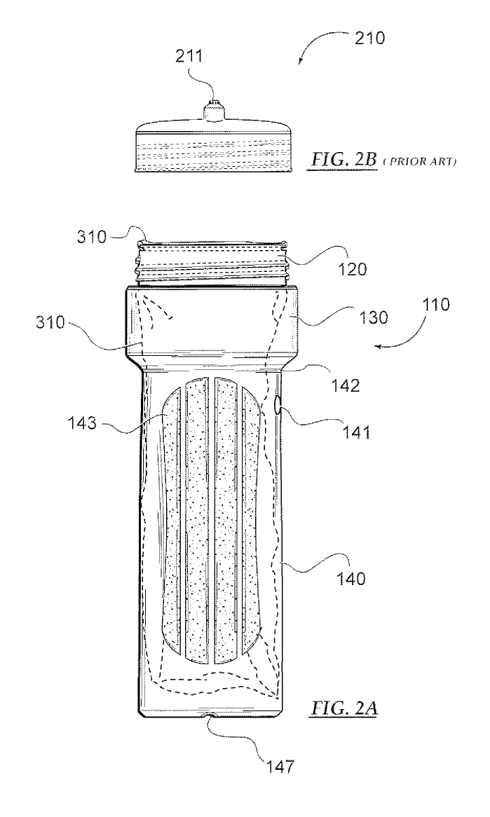

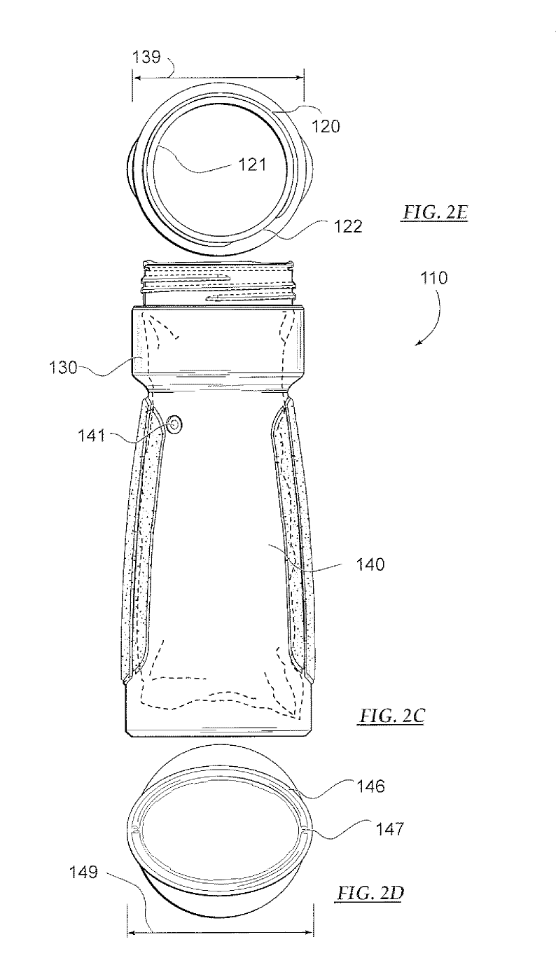

It should additionally be appreciated that the ergonomic shape and material of sports bottle 110 allow bottle 110 to be squeezed without difficulty by the user. In this exemplary embodiment 100, the bottle 110 comprises a body portion 140 that further comprises an approximately elliptical shape at its bottom end, as also shown in FIG. 2D. Further, the ergonomic shape of body portion 140 is defined by the body portion at a top end 142 being circular in a horizontal cross-section, as further described herein. This ergonomic and generally oval shape 140 is suited to be carried against the body for sports such as running, golf etc. This shape 140 also coupled to a collar portion 130 facilitates the easy use of bottle 110. It is to be understood that for other sport activities where bottle 110 might be carried elsewhere than on the body, the preferred shape may be slightly modified. One example would be to modify the shape of the sports bottle 110 to attach to a bicycle. In other embodiments, the shape of bottle 110, body portion 140, and collar portion 130 is such that it can be held in an adult hand comfortably and easily.

In the preferred embodiments, bottle 110 is composed of a low-density polyethylene, which is also referred to as LDPE. This material allows a comfortable and easy compression or squeezing of body portion 130 of bottle 110 to facilitate the delivery of the liquid to the bottle user or the easy dispensing of liquid from bottle 110 by a user.

With regard to FIG. 2A, a profile view of the preferred embodiment 110 is illustrated generally comprising mouth portion 120, body portion 140 with a collar portion 130 therebetween. The profile, or side aspect, of body portion 140 may be characterized as straight providing aerodynamic properties for bicycle applications as described herein in more detail. Hence, in the side aspect, a width at a bottom of body portion is equal to a width at a top end 142 of body portion 140 of the bottle. It is also apparent that liner 310 raps around inner 121 and outer surface 122 (FIG. 2E) of mouth portion 120. Further, raised textured surface 143 protrudes from the body portion 140 (and is not etched into body portion 140) providing traction to a hand of a user.

Also with regard to FIG. 2A, mouth portion 120, collar portion 130 and body portion 140 together form an integral unit 110. This combination is distinguishable from other designs in that any collar is not part of a cap that removably connects to the bottle 110, as may be the case in prior art applications.

With reference to FIG. 2B, the preferred embodiment is coupled to a prior art cap 210 comprising a one-way dispensing valve 211. More particularly, it is contemplated that the present invention be coupled to a valve introduced by Dark, U.S. Pat. No. 6,616,012, entitled “Fluid Dispensing Valve and Method of Use” the contents of which are incorporated by reference herein. This valve 211 is generally characterized as not unseating until a threshold pressure is achieved so that no fluid is dispensed when a bottle is simply bumped into. Additionally, the valve 211 provides a precise laminar stream having a relatively high discharge flow rate so that minimal bottle 110 tilting in required by a user.

Further, cap 210 comprising valve 211, additionally comprises a retainer and a dispensing valve body. Cap 210 is adapted to engage outer mouth portion 122 and includes a spout that defines a through-conduit having a top opening, a bottom opening, and an interior spout surface shaped to receive the dispensing valve body as can be seen in FIG. 8 through FIG. 17 of Dark. The retainer includes at least one flow aperture and an upwardly extending plug having a plug shoulder. The dispensing valve body is bounded by an exterior surface, an interior surface, a valve perimeter, and a dispensing orifice perimeter. When the dispensing valve body is positioned on the retainer, the dispensing orifice perimeter fits securely around and seals against the upwardly extending plug. Hence, and the valve perimeter forms a sealing relationship with the interior spout surface. The retainer engages the spout to seal the dispensing valve body within the spout.

Turning to FIG. 2C, a front aspect of the preferred bottle 110 is shown. FIG. 2D and FIG. 2E meanwhile represent top and bottom views thereof. As shown in FIG. 2D, the bottom of body portion 140 comprises an elliptical shape having a major 149 and a minor axis. Importantly, a width 139 of the collar portion 130 is greater than a width of the mouth portion 120; and a width 139 of the collar portion 130 is smaller than the major axis 149. As stated herein, vent hole 141 is positioned to mate with a thumb, or alternatively an index finger of a user.

Further to FIG. 2D, bottom end of body portion 140 further comprises: a ridge 146 protruding around the bottom end, the ridge bisected by the major axis 149; and a groove 147 in the ridge 146 in an area bisected by the major axis 149.

Additionally, in the preferred embodiments, bottle 110 is made of a light, liquid-tight plastic film that can collapse providing positive pressure to force potable liquid out of liner 310. Inner liner 310 is further comprised of fully biodegradable plastic. In a particular embodiment, the biodegradable inner liner 310 composition is also compostable.

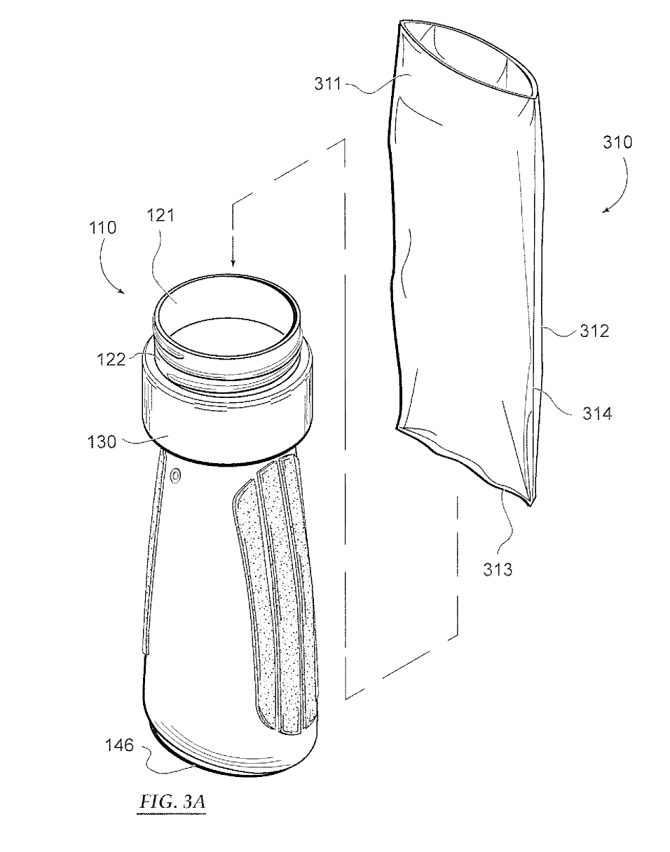

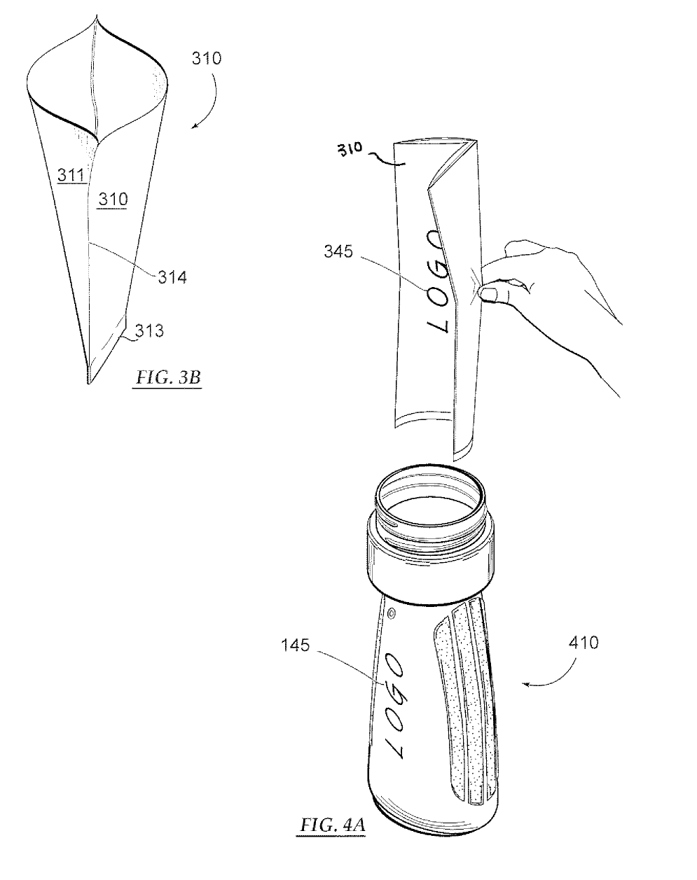

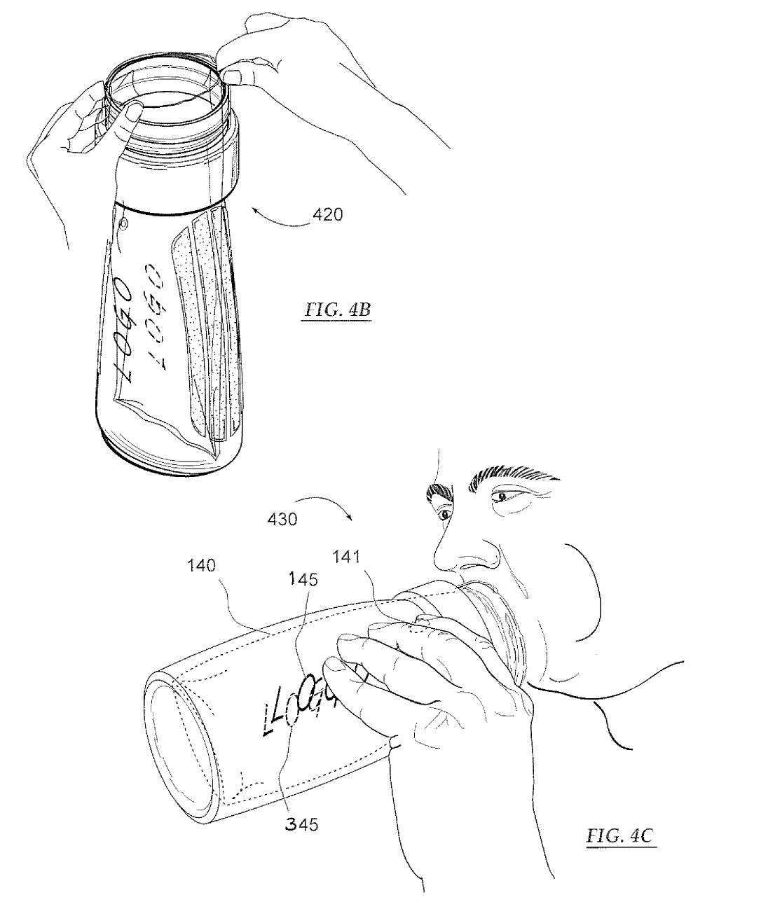

With reference to FIG. 3A, inner liner 310 is removably attached to mouth portion 120 inner 121 and outer surface 122. Additionally, inner liner 310 and mouth portion 120 will be approximately co-axial when assembled for use, as also shown in FIG. 4A. Because of the combination of vent hole 211, one way valve 141, and liner 310 being composed of a light deformable plastic, any liquid in liner 310 does not move or slosh within liner 310 and bottle 110. The liquid in essence behaves like a solid with no air allowed into liner 310 as the liquid is consumed or discarded from bottle 110. When secured bottle 100 is in contact with a user's body, the user will experience minimal to no sense that liquid carried in bottle 100 is splashing or sloshing within bottle 100. Also, bottle 100 can be carried in contact with a user's body by any means the user chooses. Examples of such means include in a waist belt possessing a compartment or harness for holding bottle 100 or in a pouch or pocket in the user's clothing that can accommodate bottle 100. The bottle 110 in a side aspect, (FIG. 2A) is very aerodynamic for use in a bicycle carrier.

Inner liner 310 may be removably attached to mouth portion 120 by any means that allows lid 210 to be attached to mouth outer surface 122. In some embodiments inner liner 310 may be removably attached to mouth 120 by slightly deforming its top opening in such a way that liner fits over outer surface 122 of the mouth portion 120. In some embodiments, it is contemplated that the attachment of inner liner 310 is the result of a tension of deformation of liner 310 in the area around outer mouth 122. The removable attachment of inner liner 310 may also be accomplished, for example, by the use of a rigid or elastic ring or tie of approximately the shape and size of outer surface 122 of mouth 120 portion. One skilled in the art will readily recognize that a ring or tie can be adjusted to apply enough pressure on inner liner 310 that it held in position in outer surface 122 of mouth 120 portion. In other embodiments, inner liner 310 may be removably attached to mouth 120 by means of any tacky or removable glue substance placed between the inner liner 310 and outer surface 122 of mouth portion 120. Inner liner 310 may be removably attached to either inner surface 121 or outer surface 122 of mouth portion 120, depending on the particular embodiment of bottle 110 that is contemplated. One skilled in the art will easily envision that liner 310 can be modified a variety of ways and still be within the scope of the invention.

Additionally, it is envisioned in some embodiments to have a threaded portion to allow cap 210 to attach to outer mouth surface 122 so that threaded engagement of cap 210 to mouth portion 120 functions to close bottle 110. Cap 210 may also attach to mouth portion 120 by a snug fit, snapping in place over mouth 120. It is further envisioned that outer surface 122 of mouth 120 in the case of a snap fit would have one or more rings on outer surface 122 to facilitate the snug and secure snap fit of cap 210. In a separate embodiment, cap 210 is integrally attached to outer mouth 122 by a small tab of LDPE accomplished during the manufacturing process. This allows cap 210 to be removed from mouth portion 120, however while still be anchored to outer surface 122.

Now with regard to FIG. 3B, inner liner 310 further comprises a front side 311 and a back side 312 connected via edge 314 comprising a fold on lateral side, the back side 312 further connected to the front side 311 via a seam 313 on a bottom side. As stated the inner liner 310 further comprises biodegradable material and ideally compostable material. Additionally inner liner 310 is of a slightly smaller circumference or perimeter than inner mouth surface 121 so that inner liner 310 can fit inside of bottle 110. Inner liner 310 is preferably also approximately the same length of depth as bottle 110 so that the volume of liquid that bottle 110 can hold is maximized in terms of the capacity of inner liner 310. A main function of inner liner 310 is the filling and subsequent collapsing as a user dispenses or removes liquid from bottle 100 or when liquid in liner 310 is otherwise emptied from liner 310. It should further be noted that the bottle 110 could be realized with various sizes for children or as desired by a user. As an example and not by way of limitation, the size ranges from 6 oz to 30 oz.

FIG. 4A through FIG. 4C illustrate a preferred method of the present invention. More specifically, the method of installing a liner 310 to a sports bottle comprises the steps of removing the cap 210 on the bottle 110; inserting 410 the liner 310 into the bottle 110; aligning a logo 345 on the liner 310 with a logo 145 on the outside of the bottle 110; rolling 420 the liner over the threads; placing a mouth up to the bottle 110 opening 120; and blowing 430 into the liner 310 (as if a user were blowing up a balloon) until the liner 310 expands inside the bottle 110 that will aid in getting a full till of a user's beverage in the bottle 110. Additional steps comprise: filling the bottle 110 with a user's favorite beverage; and securing the cap 210, ensuring that while tightening the cap 210, the liner 310 does not rotate causing a misalignment of the logos 145, 345.

In summary, the principal advantages of the present invention 100 include the prevention of sloshing or annoying noise clue to the one way valve 210 and bottle liner 310 that shrinks as the liquid is used, making it 100 feel more like a solid. Also the invention 100 prevents residual bacteria or bad aftertaste due to the disposable and fully biodegradable liner 310. Further the invention 100 removes any necessity to clean bottles. Also, the invention 100 boasts an ergonomic shape 120, 130, 140 and feel allowing for comfort mile after mile. The preferred embodiment 100 also provides a very flexible and squeezable design enabling you to get your water or favorite mix without even tilting the bottle 100. And as stated, the side aspect (FIG. 2A) is extremely aerodynamic when turned sideways (great for on a bicycle).

While the particular Ergonomic Sports Bottle Having Disposable Liner as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A bottle comprising:
a mouth portion at a top end of the bottle;
a body portion, the body portion having a diameter at a top end of the body portion; and
a collar portion therebetween, wherein the mouth portion has a diameter, and wherein the collar portion has a diameter greater than both the diameter at the top end of the body portion and the mouth portion diameter, and wherein the mouth portion, the collar portion and body portion together form an integral unit.

2. The bottle of claim 1, the body portion further comprising:
first and second lateral sides in a side aspect; and
third and fourth lateral sides in a front aspect, wherein the first and second lateral sides in a side aspect form a straight profile of the sides, and wherein the third and fourth lateral sides are curved in the front aspect, the third and fourth lateral sides further comprising a textured surface providing traction to a hand of a user.

3. The bottle of claim 1, further comprising:
an outer surface;
an inner surface; and
a disposable inner liner for receiving and holding a liquid, wherein the inner liner is removably attached to the mouth and the outer surface, and wherein the disposable liner is surrounded by the inner surface of the bottle.

4. The bottle of claim 3, further comprising:
squeezable low density polyethylene (LDPE) material;
a cap having a one-way valve, configured to fit over the mouth and over the inner liner removably attached to the mouth and the outer surface; and
a vent hole at an upper area of the body portion, such that, when a user places a finger over the vent hole and squeezes, the liquid is forced out of the one way valve thereby lowering pressure within the inner liner thereby causing the liner to collapse, and wherein a collapsing liner functions to dampen down sloshing of a remaining liquid in the inner liner, and when a user releases the finger over the vent hole pressure equalizes between the inner and outer liner.

5. The bottle of claim 3, the inner liner further comprising:
a front side; and
a back side connected to the front side with and edge comprising a fold on lateral side, the back side further connected to the front side via a seam on a bottom side, the inner liner further comprising biodegradable material.

6. The bottle of claim 1, the body portion further comprising a bottom end including an ellipse having a major axis and a minor axis, wherein the minor axis equals the diameter at the top end of the body portion.

7. The bottle of claim 6 wherein the major axis is greater than a width of the collar portion, and wherein the width of the collar portion is greater than a width of the mouth portion.

8. The bottle of claim 6, the bottom end further comprising:
a ridge protruding around the bottom end, the ridge bisected by the major axis; and
a groove in the ridge in an area bisected by the major axis.

9. A bottle comprising:
a mouth portion at a top end of the bottle, the mouth portion having an inner and an outer surface;
a body portion including a vent hole, and
a disposable inner liner for receiving and holding a liquid, wherein the disposable inner liner is removably attached about the inner and outer surface of the mouth.

10. The bottle of claim 9, the body portion further comprising:
a top end having a diameter; and
a bottom end including an ellipse having a major axis and a minor axis, wherein the minor axis equals the diameter at the top end of the body portion.

11. The bottle of claim 9, the body portion further comprising:
first and second lateral sides in a side aspect; and
third and fourth lateral sides in a front aspect, wherein the first and second lateral sides in a side aspect form a straight profile of the sides, and wherein the third and fourth lateral sides are curved in the front aspect, the third and fourth lateral sides further comprising a textured surface providing traction to a hand of a user.

12. The bottle of claim 9, further comprising a collar portion between the mouth portion and the body portion, wherein the mouth portion has a diameter, and wherein the collar portion has a diameter greater than both the diameter at the top end of the body portion and the mouth portion diameter, and wherein the mouth portion, the collar portion and body portion together form an integral unit.

13. The bottle of claim 9, further comprising:
squeezable low density polyethylene (LDPE) material; and
a cap having a one-way valve, configured to fit over the mouth and over the inner liner removably attached about the inner and outer surface of the mouth, wherein, when a user places a finger over the vent hole and squeezes, the liquid is forced out of the one way valve thereby lowering pressure within the inner liner thereby causing the liner to collapse, and wherein a collapsing liner functions to dampen down sloshing of a remaining liquid in the inner liner, and when a user releases the finger over the vent hole pressure equalizes between the inner and outer liner.

14. The bottle of claim 9, the inner liner further comprising:
a front side; and
a back side connected to the front side with and edge comprising a fold on lateral side, the back side further connected to the front side via a seam on a bottom side, the inner liner further comprising biodegradable material.

15. A method of lining a sports bottle comprising:
providing a biodegradeable liner;
inserting the liner through a mouth of the sports bottle;
rolling the liner over the mouth of the sports bottle;
forcing air into the liner to expand the liner within the sports bottle; and
venting air in an area between the liner and the sports bottle out a vent hole in a body portion of the sports bottle.

16. The method of lining a sports bottle of claim 15, further comprising smoothing out the liner over the mouth of the sports bottle.

17. The method of lining a sports bottle of claim 15, wherein the inserting the liner through the mouth of the sports bottle comprises folding the liner lengthwise to assist the inserting.

18. The method of lining a sports bottle of claim 15, further comprising lining up a logo on the liner with a logo on the sports bottle preceding the forcing air and following the inserting.

19. The method of lining a sports bottle of claim 15, further comprising:
providing threads to an outside of the mouth of the sports bottle;
securing a cap to the mouth of the sports bottle; and
ensuring the liner does not rotate causing a misalignment of the logo on the liner with the logo on the sports bottle.
